(19) United States
(12) Patent Application Publication
(10) Pub. No.: US 2024/0332558 A1
(43) Pub. Date: Oct. 3, 2024

(54) SOLID OXIDE ELECTROCHEMICAL DEVICE AND UNIT CELL THEREOF

(71) Applicant: NISSAN NORTH AMERICA, INC., Franklin, TN (US)

(72) Inventors: Mohammed Hussain ABDUL JABBAR, Novi, MI (US); Sandeep PATIL, Farmington Hills, MI (US)

(21) Appl. No.: 18/295,070

(22) Filed: Apr. 3, 2023

(51) Int. Cl. H01M 8/0258; H01M 4/86; H01M 8/1213; H01M 8/1231

(52) U.S. Cl. CPC H01M 8/0258; H01M 4/8605; H01M 8/1213; H01M 8/1231; H01M 2008/1293

(57) ABSTRACT

An anode structure for use in a solid oxide electrochemical device includes a first end that is a fuel channel. The anode structure further includes a second end that is a fuel channel. The anode structure further includes longitudinal body extending between the first and second ends. The first thickness has a pair of end portions that are provided at the first and second ends. The first thickness has a body portion provided along the longitudinal body. The second thickness is provided along the longitudinal body in an alternating order with the body portion of the first thickness. The second thickness is thinner than the first thickness.

### BACKGROUND

### Technical Field

The present disclosure generally relates to a solid oxide electrochemical device and unit cell thereof. More specifically, the present disclosure relates to a solid oxide electrochemical device and unit cell thereof that is configured to be compact.

### Background Information

Solid oxide fuel cells having an electrolyte-supported configuration have poor mechanical strength and exhibit poor performance due to high electrolyte resistance. Solid oxide fuel cells having an electrode-supported configuration are considered high performance due to thin electrolyte and somewhat stronger than the electrolyte-supported configurations. However, the solid oxide fuel cells having an electrode-supported configuration also fail to meet the strength, vibration resistance, quick start-up, heat-transfer and performance requirements needed for automotive and specific stationary applications.

### SUMMARY

In view of the state of the known technology, one aspect of the present disclosure is to provide an anode structure for use in a solid oxide electrochemical device comprising a first end that is a fuel channel. The anode structure further includes a second end that is a fuel channel. The anode structure further includes longitudinal body extending between the first and second ends. The first thickness has a pair of end portions that are provided at the first and second ends. The first thickness has a body portion provided along the longitudinal body. The second thickness is provided along the longitudinal body in an alternating order with the body portion of the first thickness. The second thickness is thinner than the first thickness.

In view of the state of the known technology, another aspect of the present disclosure is to provide a solid oxide electrochemical device comprising a first cathode layer and a second cathode layer. The solid oxide electrochemical device further comprises an electrolyte layer that is provided between the first and second cathode layers. The electrolyte layer has a top portion and a bottom portion. The solid oxide electrochemical device further comprises an anode layer provided between the top and bottom portions of the electrolyte layer.

In view of the state of the known technology, another aspect of the present disclosure is to provide a solid oxide electrochemical device unit cell comprising. The unit cell comprises a first solid oxide electrochemical device and a second solid oxide electrochemical device. The first solid oxide electrochemical device has a cathode layer. The second solid oxide electrochemical device has a cathode layer and a metal conductive layer. The metal conductive layer is disposed between the cathode layer of the first solid oxide electrochemical device and the cathode layer of the second solid oxide electrochemical device. The metal conductive layer further has a first side having a plurality of first openings facing and channeling air to the cathode layer of the first solid oxide electrochemical device. The metal conductive layer further has a second side having a plurality of second openings facing and channeling air to the cathode layer of the second solid oxide electrochemical device.

### BRIEF DESCRIPTION OF THE DRAWINGS

Referring now to the attached drawings which form a part of this original disclosure:

FIG. 1 is a perspective view of a solid oxide electrochemical device unit cell in accordance with an illustrated embodiment;

FIG. 2 is a perspective view of a solid oxide electrochemical device of the unit cell of FIG. 1:

FIG. 3 is an enlarged perspective view of the unit cell of FIG. 1:

FIG. 4 is a cross-sectional view of the unit cell of FIG. 1;

FIG. 5 is a cross-sectional view of the solid oxide electrochemical device of FIG. 2; and

FIG. 6 is a flowchart for a method of making the solid oxide electrochemical device.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

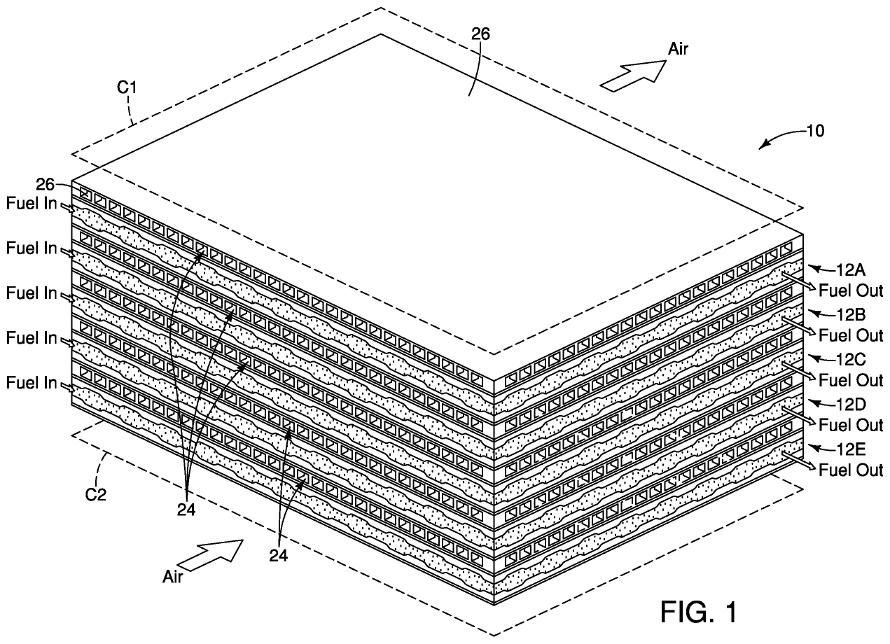

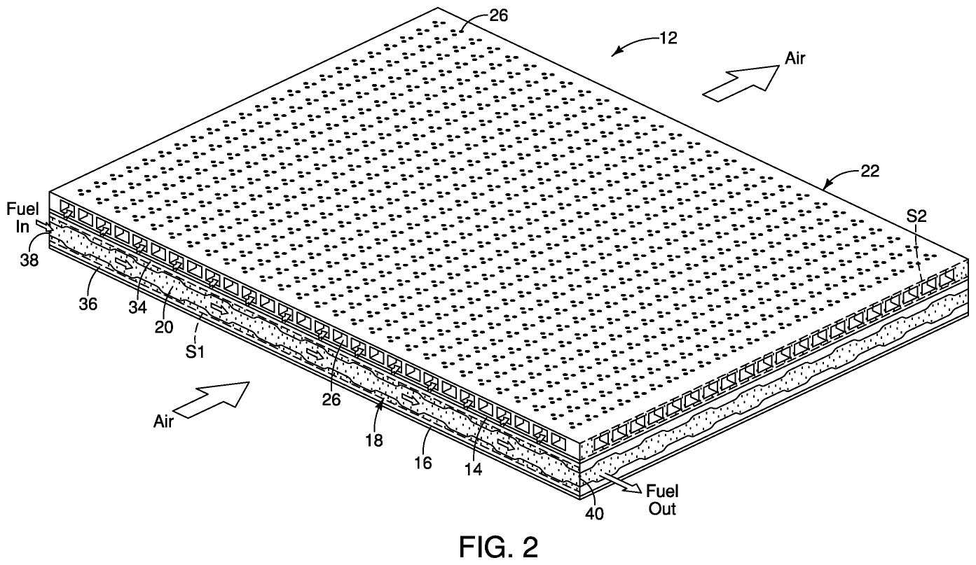

Referring initially to FIG. 1, a solid oxide electrochemical device unit cell 10 (hereinafter “unit cell 10”) is illustrated in accordance with an embodiment. The unit cell 10 is comprised of a plurality of solid oxide electrochemical devices 12 that are stacked. Referring to FIG. 2, a single solid oxide electrochemical device 12 that can be considered a solid oxide fuel cell is illustrated. The single oxide electrochemical device (hereinafter “SOFC 12”) of FIG. 2 illustrates any one of the SOFC's 12 of the unit cell 10 illustrated in FIG. 1. As shown, the unit cell 10 preferably comprises a plurality of SOFCs 12A, 12B, 12C, 12D and 12E that are stacked. For brevity, only a single SOFC 12 will be described herein.

As seen in FIG. 1, the unit cell 10 can include a top cover C1 and a bottom cover C2 that are disposed over the top and bottom of the unit cell 10. The top cover C1 and the bottom cover C2 can be metal covers.

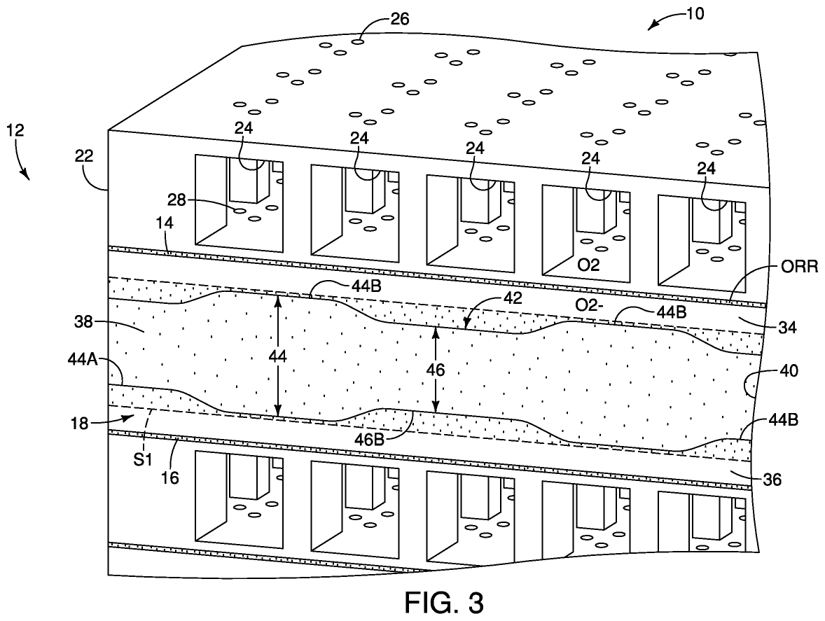

Referring to FIGS. 2 and 3, the SOFC 12 comprises a first (top) cathode layer 14 and a second (bottom) cathode layer 16. The SOFC 12 further comprises an electrolyte layer 18. As shown, the electrolyte layer 18 is provided between the first and second cathode layers 14 and 16 such that the electrolyte layer 18 is sandwiched therebetween. The SOFC 12 further comprises an anode layer 20 (e.g., anode structure) that is provided within the electrolyte layer 18. The SOFC 12 further comprises a metal conductive layer 22. The metal conductive layer 22 is provided over the first cathode layer 14 such the first cathode layer 14 is sandwiched between the electrolyte layer 18 and the metal conductive layer 22.

Referring back to FIG. 1, the top SOFC 12A includes a top cathode layer that does not have any top openings. The SOFC 12 of FIGS. 2 and 3 are considered any of the SOFCs 12B to 12E that includes openings at the top cathode layer 14. However, the top cathode layer of the unit cell 10 does not include openings on the top surface.

The anode layer 20 and cathode layers 14 and 16 of the SOFC 12 are porous. The anode layer 20 is preferably nickel-based such that the anode layer 20 enables oxygen deficient gases (e.g., hydrogen and natural gases) to flow through the anode layer 20. The metal conductive layer 22 enables oxygen rich air to flow therethrough. The electrolyte layer 18 is provided therebetween to form a seal between the anode layer 20 and the first and second cathode layers 14 and 16. The electrolyte layer 18 is also provided to conduct ions between the anode layer 20 and the first and second cathode layers 14 and 16, as will be further discussed. In the illustrated embodiment, the cathode layers 14 and 16 are each 30 μms in thickness. The anode layer 20 has alternating thicknesses that preferably measures 60 to 80 μms, as will be further discussed below.

The SOFC 12 of the illustrated embodiment is provided as a compact battery-like fuel cell that prevents fuel (e.g., hydrogen, propane and natural gas, etc.) and airflow from intermixing. The SOFC 12 is designed to be conveniently stacked and to be portable like current batteries in vehicles.

As shown in FIGS. 1 to 3, the metal conductive layer 22 forms a top layer of the SOFC 12 and a top layer of the unit cell 10 when the SOFC 12s are stacked. In the unit cell 10, the metal conductive layers 22 are considered interconnecting layers that direct air to the SOFC 12s stacked above and below the respective metal conductive layer 22. That is, the metal conductive layer 22 includes a plurality of airflow channels 24 provided therethrough that enable air intake and output throughout the SOFC 12. In particular, as best seen in FIG. 3, the metal conductive layer 22 has a first side having a plurality of first openings 26 that channels air in a direction upwards of the metal conductive layer 22. The metal conductive layer 22 further has a second side having a plurality of second openings 28 that channels air in a direction below the metal conductive layer 22.

As seen in FIG. 2, the SOFC 12 includes one or more first seals S1 and one or more second seals S2. The first seal S1 is provided over opposite ends of the anode layer 20 to channel fuel in a direction parallel to the direction the seals S1 extends. The second seals S2 are provided over opposite ends of the airflow channels 24 of the metal conductive layer 22 to channel air in a direction that is parallel to the direction of the seals S2 extends. The first and second seals S1 and S2 can be made of any sealing material such as rubber.

As shown in FIG. 3, the airflow channels 24 can include a plurality of air inlets 30 and a plurality of air outlets 32. The air inlets 30 and outlets 32 can be formed by laser drilling holes in a metal substrate. It will be apparent to those skilled in the battery field from this disclosure that the inlets 30 and outlets 32 can have any suitable shape and diameter as appropriate to allow airflow through the metal conductive layer 22.

As shown in FIGS. 1 and 2, fuel is provided to the anode layer 20 such that the fuel provided to the anode layer 20 flows in a counter current direction (as shown in FIG. 1 or perpendicular as shown in FIG. 2) with respect to the airflow direction that flows the metal conductive layer 22. The airflow channels 24 of the metal conductive layer 22 are interconnected via the inlets 30, the outlets 32 and the first and second openings 28. As such, the metal conductive layer 22 conducts electricity throughout all directions.

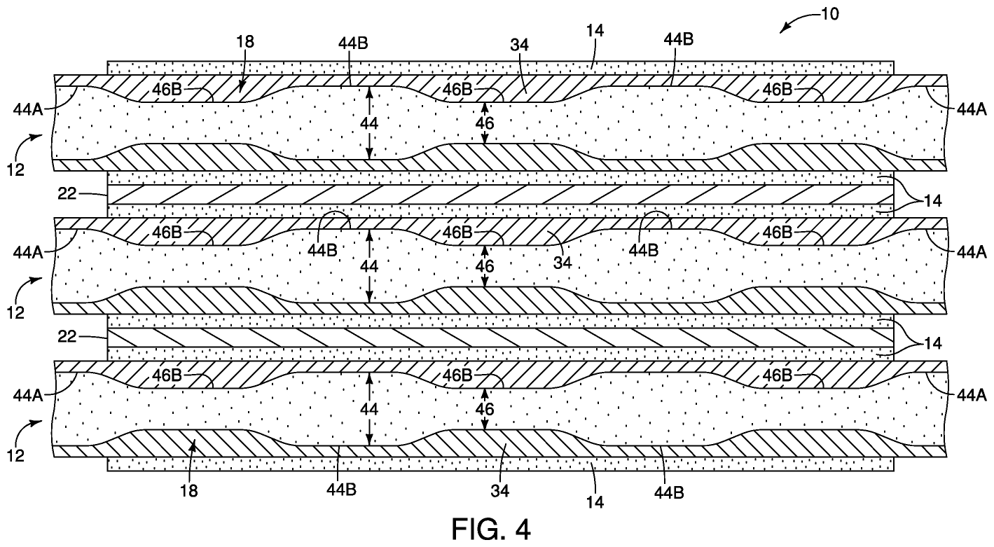

As best seen in FIGS. 3 to 5, the cathode layers 14 and 16 are thin layers that are approximately 30 μm in thickness each. The cathode layers 14 and 16 are porous and have a porosity of 30-60%. The cathode layers 14 and 16 are identical with respect to each other and are made of any suitable cathode material for a SOFC 12. The cathode material is a low temperature material that sinters at a temperature of 850° C. or less in air. For example, the cathode material can be samarium strontium cobalt oxide (SSC), having the formula SrSmCoO₃, PrBaSrCoFeO, or any suitable perovskite oxide having the general formula ABO₃. Other non-limiting examples of materials that can be used as the cathode layers 14 and 16 include perovskite cathodes, (La_{0.8}Sr_{0.2})_{0.95} MnO₃ (LSM), La_{0.6}Sr_{0.4}CoO₃ (LSC), Sr_{0.5}Sm_{0.5}O₃ (SSC), Ba_{0.5}Sr_{0.5}Co_{0.8}Fe_{0.2}O₃ (BSCF), (La_{0.6}Sr_{0.4})_{0.95}(Co_{0.2}Fe_{0.8})O₃ (LSCF), and PrBa_{0.5}Sr_{0.5}Co_{1.5}Fe_{0.5}O_{5+y} (PBSCF) with and without GDC, a ceria based doped material. The cathode layers 14 and 16 can be formed via electrophoretic deposition (EPD) of the materials mentioned onto the surface of the electrolyte layer 18. In this way, the cathode layer can be formed to have a small thickness.

The first cathode layer 14 receives air from the second openings 28 of the of the metal conductive layer 22 that is stacked above the first cathode layer 14. The second cathode layer 16 receives air from the first openings 26 of the metal conductive layer 22 that is stacked below the second cathode layer 16. Therefore, the first and second cathode layers 14 and 16 are oxygen rich. The top and bottom portion of the stack is dense.

As best seen in FIG. 3, the first and second cathode layers 14 and 16 include oxygen reduction reaction (ORR) catalyst. When the oxygen rich gases are introduced to the cathode layers 14 and 16, the oxygen reacts with the ORR catalyst to produce oxide ion. Oxygen ions are produced as a byproduct of the catalytic reaction. This reaction at the cathode layers 14 and 16 can be considered an oxidization reduction reaction for cathodic reduction of oxygen. In the illustrated embodiment, these cathodic reactions are occurring at both the first and second cathode layers 14 and 16, so that they are occurring both above and below the anode layer 20. The ORR catalyst can be, for example, doped praseodymium (III,IV) oxide (PrOx) with transition metals or noble metals.

In the SOFC 12, the electrolyte layer 18 is provided between the first and second cathode layers 14 and 16. The electrolyte layer 18 includes a solid oxide ceramic material. The electrolyte layer 18 has a thickness of approximately 5-15 μm in the Z-direction (i.e., stacking direction). Preferably, the electrolyte layer 18 has a thickness of 10 μm or less. The electrolyte layer 18 may be formed via EPD of the solid oxide ceramic material on the top surface of the anode layer 20. By forming the electrolyte layer 18 via EPD, the electrolyte layer 18 can desirably be formed to have a small thickness.

The electrolyte layer 18 can be made of any suitable solid oxide ceramic material. The electrolyte layer 18 can be dense and preferably with a porosity of 1% or less. In this way, the electrolyte layer 18 can be stacked more easily without using adhesives, thereby eliminating the undesirable sealing issues with conventional metal-supported SOFC 12s. The electrolyte layer 18 is dense to seal the fuel in the anode layer 20 from the air in the metal conductive layer 22 to prevent these elements from interacting. For example, the electrolyte layer 18 can have ScCeSZ. The electrolyte layer 18 can be made with materials selected from the group consisting of doped bismuth oxide, yttria-stabilized zirconia (YSZ), scandia- and yttria-stabilized zirconia (ScYSZ), and scandia-, cerium- and/or yttria-stabilized zirconia (ScCeYSZ).

As shown, the anode layer 20 is provided within the electrolyte layer 18. With the anode layer 20 provided therethrough, the electrolyte layer 18 has a top portion 34 that is disposed over the anode layer 20 and a bottom portion 36 that is disposed underneath the anode layer 20. The electrolyte layer 18 is provided to conduct ions (e.g., oxide ions O2⁻) at the electrolyte layer 18. As stated, the ORR oxidization reduction reaction occurs at the cathode layer to produce oxide ions. The hydrogen oxidation reaction HOR occurs at the anode layer 20 to provide protons. These oxide ions and proton ions meet in the electrode/electrolyte interface to react to form water and electricity. As a result, electricity is the outputted from the SOFC 12.

Referring to FIGS. 3 to 5, the anode layer 20 is provided between the top and bottom portions 34 and 36 of the electrolyte layer 18. Alternatively speaking, the anode layer 20 is provided to the electrolyte layer 18 to segregate the electrolyte layer 18 into top and bottom portions 34 and 36. The anode layer 20 is made of porous metal such that the anode layer 20 has a spongelike consistency. The anode layer 20 is thirty to fifty percent porous so that fuel (e.g., hydrogen H₂ gas) can be introduced. As shown, the anode layer 20 has a tortuous pathway like an open cell sponge.

The anode layer 20 is formed of a porous anode material that can have a plurality of pores formed therein. The anode layer 20 is preferably formed via EPD of the porous anode material on a metal substrate in the Z-direction. The anode layer 20 can include a metal oxide and a solid oxide ceramic material. For example, the metal oxide may be nickel oxide (NiO), and the solid oxide ceramic material may be scandia ceria stabilized zirconia (ScCeSZ) or doped ceria. The anode layer 20 can include approximately 40-60% by volume of NiO and approximately 40-60% by volume of ScCeSZ. The anode layer 20 can include 50% by volume of NiO and 50% by volume of ScCeSZ. However, the anode layer 20 can also include additives such as tin (Sn). It should be understood that the ScCeSZ material also includes gadolinium (Gd) as a dopant for the ceria (CeOₓ) in the ScCeSZ material.

Non-limiting examples of materials that can be used to form the anode layer 20 can include Ni—YSZ, nickel-gadolinium-doped ceria (Ni-GDC), nickel-samarium-doped ceria (Ni-SDC), Ni—ScYSZ, and perovskite anodes (e.g., SrCo_{0.2}Fe_{0.4}Mo_{0.4}O₃). Therefore, the anode layer 20 is provided as a nickel or oxide conductor. The anode layer 20 has oxygen deficient gases like hydrogen and natural gas. In the illustrated embodiment, the anode layer 20 of the SOFC 12 has a longitudinal length of approximately 10 centimeters.

The anode layer 20 includes a first end 38 that is a fuel channel. The anode layer 20 further includes a second end 40 that is a fuel channel. Fuel is introduced to the SOFC 12 at either the first or second ends 38 and 40 in a direction that is perpendicular to the air intake of the metal conductive layer 22. The anode layer 20 further includes a longitudinal body 42 extending between the first and second ends 38 and 40.

In the illustrated embodiment, the anode layer 20 includes a first thickness 44 and a second thickness 46 that is thinner than the first thickness 44. The first thickness 44 having a pair of end portions 44A that are provided at the first and second ends 38 and 40. In other words, the first thickness 44 is provided at the first and second ends 38 and 40 of the anode layer 20 at the fuel intake. The first thickness 44 has a body portion 44B provided along the longitudinal body 42. In the illustrated embodiment, the first thickness 44 includes a plurality of body portions 44B that are provided along the longitudinal body 42 in an alternating order with the second thickness 46.

The second thickness 46 is provided along the longitudinal body 42 in an alternating order with the body portion of the first thickness 44. More specifically, the second thickness 46 includes a plurality of body portions 46B that are provided along the longitudinal body 42 in an alternating order with the first thickness 44.

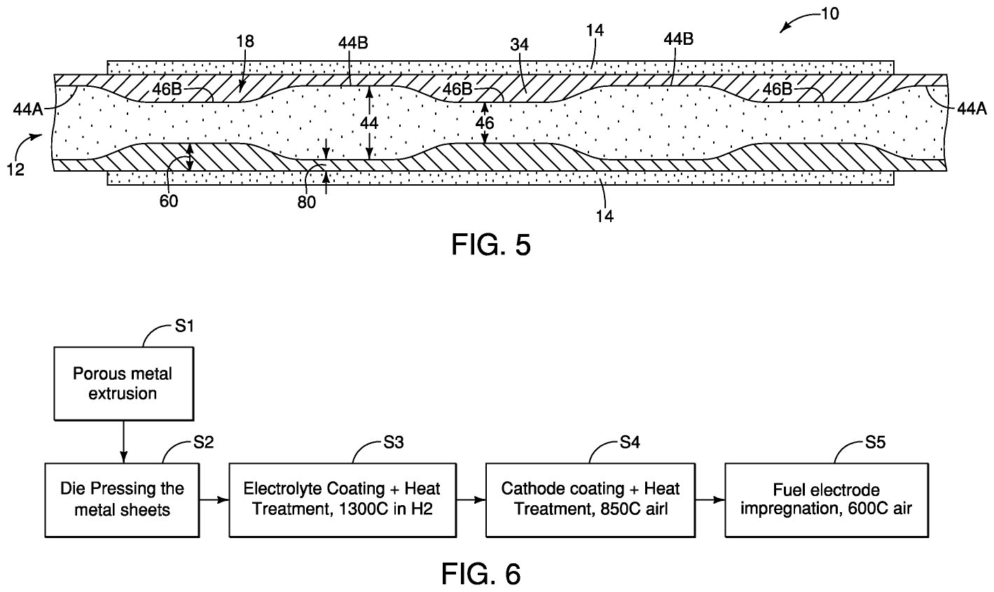

The first thickness 44 can be considered a high performance portion of the anode layer 20. The first thickness 44 decreases the distance between the anode layer 20 and cathode layers 14 and 16 and increases the amount of time the fuel can dwell in this portion of the anode. Each of the top and bottom portions 34 and 36 of the electrolyte layer 18 is approximately 2 μm at the first thickness 44, as seen in FIG. 5. Therefore, faster conversions are possible at the first thickness 44 for methane and hydrogen conversions. In particular, the first thickness 44 allows for faster conversions for reforming catalytic methane.

Preferably, the first thickness 44 is 1.5 centimeters in length at each of the first and second ends 38 and 40. The body portions of the first thickness 44 are also approximately 1.5 centimeters in length each. Preferably, the first thickness 44 is 80 μms in thickness at each of the first and second ends 38 and 40. The body portions of the first thickness 44 are also approximately 80 μm in thickness. It will be apparent to those skilled in the battery field from this disclosure that dimensions of the first thickness 44 can include a range, such as 60 to 100 μm. More preferably, in the illustrated embodiment, the first thickness 44 is approximately 80 μm in thickness.

The second thickness 46 can be considered a strengthening portion of the anode layer 20. Preferably, the body portions of the second thickness 46 are approximately 60 μm in thickness each. The second thickness 46 has a same longitudinal length as the first thickness 44, that is 1.5 centimeters in length. It will be apparent to those skilled in the electrochemistry field from this disclosure that dimensions of the second thickness 46 can include a range, such as 50 to 70 μms. More preferably, in the illustrated embodiment, the second thickness 46 is approximately 60 μms in thickness. A ratio of the first thickness 44 to the second thickness 46 can be in a range of 1.2 to 1.5. More preferably, the ratio of the first thickness 44 to the second thickness 46 is 1.33. At the second thickness 46, the O2⁻ ions are traveling fast therethrough to enable faster reactions and so that the electrodes can anchor to the anode layer 20.

With the arrangement discussed, the anode layer 20 of the illustrated embodiment is much thinner than conventional anode layers 20 because the anode layer 20 is made to be stronger than conventional anodes. Further, the alternating thicknesses of the anode layer 20 enable the anode layer 20 of the illustrated embodiment to be overall thin, strong and flexible.

The anode layer 20 includes HOR catalyst to convert hydrogen into H⁺ ions and conduct hydrogen oxidation reaction at the anode layer 20. The catalyst can be, for example, cerium-zirconium mixed oxides (CeZrO_{2-y}) with transition metals or noble metals. Here, hydrogen (H₂) introduced as fuel to the anode layer 20 interacts with the HOR catalyst to produce H⁺ protons and then water as part of the HOR catalytic reaction.

In the SOFC 12, the anode side reaction is generally represented by the formula:

$$\\ {H}_{2} + {O}^{{}_{} 2 -} \to {H}_{2} O + 2 {e}^{{}_{} -}$$

The cathode side reaction is generally represented by the equation:

$$\\ 1 / 2 {O}_{2} + 2 {e}^{{}_{} -} \to {O}^{{}_{} 2 -} —$$

The overall SOFC reaction is represented by the equation:

$$\\ {H}_{2} + 1 / 2 {O}_{2} \to {H}_{2} O$$

In the illustrated embodiment, the fuel has more dwell time in the anode layer 20 at the first thickness 44. If the anode uses methane or natural gas, the catalyst on the anode layer 20 will have to reform (e.g., cause the methane to become hydrogen first) the fuel before protons are created. If the anode uses hydrogen fuel, reforming the fuel is not necessary and the anode layer 20 creates proton ions as a result of the HOR catalytic reaction.

Referring back to FIG. 1, the unit cell 10 comprises a first SOFC 12 and a second SOFC 12 that are stacked. As shown the unit cell 10 further comprises a third SOFC 12 that is stacked to the first and second SOFC 12's. In particular, the unit cell 10 includes five stacked SOFC 12's that are identical. The metal conductive layers 22 of the unit cell 10 are considered interconnecting layers between the stacked SOFC 12A-E to transfer air to the SOFC 12 on either sides of the metal conductive layers 22. For example, the metal conductive layer 22 is disposed between the cathode layer of the first solid oxide electrochemical device and the cathode layer of the second solid oxide electrochemical device, in FIG. 1. The anode layers 20 of the unit cell 10 are porous to channel fuel to the electrolyte layers 18 of the different SOFCs 12 adjacent to the respective anode layers 20.

Referring now to FIG. 6, a method of making the SOFC 12 described above will now be discussed. The method comprises extruding a porous metal into a metal sheet in step S1. The method further comprises die pressing the metal sheet to create the anode layer 20 in step S2. Here, die pressing the metal sheet includes creating the first thickness 44 and the second thickness 46 for the anode layer 20. The method further comprises coating the metal sheet with electrolyte under heat to form the electrolyte layer 18 having the anode layer 20 embedded therein in step S3. The method further comprises coating the electrolyte layer 18 in a cathode material under heat in step S4. The method further comprises impregnating the electrolyte layer 18 and cathode with anode in step S5.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the solid oxide electrochemical device and unit cell thereof. Accordingly, these terms, as utilized to describe the present invention should be interpreted relative to a vehicle equipped with the solid oxide electrochemical device and unit cell thereof.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An anode structure for use in a solid oxide electrochemical device, the anode structure comprising:
a first end that is a fuel channel;
a second end that is a fuel channel;
a longitudinal body extending between the first and second ends;
a first thickness having a pair of end portions that are provided at the first and second ends, the first thickness having a body portion provided along the longitudinal body; and
a second thickness that is provided along the longitudinal body in an alternating order with the body portion of the first thickness, the second thickness being thinner than the first thickness.

2. The anode structure according to claim 1, wherein
the first thickness includes a plurality of body portions that are provided along the longitudinal body in an alternating order with the second thickness.

3. The anode structure according to claim 1, wherein
the second thickness includes a plurality of body portions that are provided along the longitudinal body in an alternating order with the first thickness.

4. The anode structure according to claim 2, wherein
the second thickness includes a plurality of body portions that are provided along the longitudinal body in an alternating order with the first thickness.

5. The anode structure according to claim 1, wherein
a ratio of the first thickness to the second thickness is between 1.1 to 1.5.

6. The anode structure according to claim 1, wherein
the first thickness is substantially 80 microns.

7. The anode structure according to claim 6, wherein
the second thickness is substantially 60 microns.

8. A solid oxide electrochemical device, comprising
a first cathode layer and a second cathode layer;
an electrolyte layer that is provided between the first and second cathode layers, the electrolyte layer having a top portion and a bottom portion;
an anode layer provided between the top and bottom portions of the electrolyte layer.

9. The solid oxide electrochemical device according to claim 8, further comprising
a metal conductive layer provided over the first cathode layer such the first cathode layer is sandwiched between the electrolyte layer and the metal conductive layer.

10. The solid oxide electrochemical device according to claim 8, wherein
the metal conductive layer has a plurality of air flow channels provided therethrough.

11. The solid oxide electrochemical device according to claim 8, wherein
the anode layer includes a first thickness and a second thickness that is thinner than the first thickness.

12. The solid oxide electrochemical device according to claim 11, wherein
the anode layer further includes
a first end that is a fuel channel,
a second end that is fuel channel,
a longitudinal body extending between the first and second ends,
the first thickness having a pair of end portions that are provided at the first and second ends.

13. The solid oxide electrochemical device according to claim 12, wherein
the first thickness has a body portion provided along the longitudinal body, and the second thickness is provided along the longitudinal body in an alternating order with the body portion of the first thickness.

14. The solid oxide electrochemical device according to claim 13, wherein
a ratio of the first thickness to the second thickness is 1.33.

15. The solid oxide electrochemical device according to claim 14, wherein
the first thickness is substantially 80 microns.

16. The solid oxide electrochemical device according to claim 15, wherein
the second thickness is substantially 60 microns.

17. A solid oxide electrochemical device unit cell comprising:
a first solid oxide electrochemical device having a cathode layer; and
a second solid oxide electrochemical device having a cathode layer and a metal conductive layer, the metal conductive layer being disposed between the cathode layer of the first solid oxide electrochemical device and the cathode layer of the second solid oxide electrochemical device, the metal conductive layer further having a first side having a plurality of first openings facing and channeling air to the cathode layer of the first solid oxide electrochemical device, the metal conductive layer further having a second side having a plurality of second openings facing and channeling air to the cathode layer of the second solid oxide electrochemical device.

18. The solid oxide electrochemical device unit cell according to claim 17, wherein
the first solid oxide electrochemical device includes an electrolyte layer, and
the second solid oxide electrochemical device includes an electrolyte layer and an anode layer, the anode layer channeling fuel to the electrolyte layer of the first solid oxide electrochemical device and the electrolyte layer of the second solid oxide electrochemical device.

19. The solid oxide electrochemical device unit cell according to claim 18, further comprising
a third solid oxide electrochemical device having a cathode layer and a metal conductive layer, the metal conductive layer being disposed between the second solid oxide electrochemical device and the cathode layer of the third solid oxide electrochemical device and, the metal conductive layer further having a first side having a plurality of first openings facing and channeling air to the second solid oxide electrochemical device, the metal conductive layer further having a second side having a plurality of second openings facing and channeling air to the cathode layer of the third solid oxide electrochemical device.

20. The solid oxide electrochemical device unit cell according to claim 18, wherein
the anode layer of the second solid oxide electrochemical device has a porosity ranging from 30% to 50%.
